(19) United States
(12) Patent Application Publication
(10) Pub. No.: US 2009/0305056 A1
(43) Pub. Date: Dec. 10, 2009

(54) THERMAL HEAD

(75) Inventors: Tsuneyuki Sasaki, Fukushima-ken (JP); Hirotoshi Terao, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/477,415

(22) Filed: Jun. 3, 2009

(30) Foreign Application Priority Data
Jun. 9, 2008 (JP) 2008-150375

(51) Int. Cl. B32B 17/06

(52) U.S. Cl. 428/426

(57) ABSTRACT

A thermal head has three-layer structure that includes a heat insulating layer on which heating elements are formed, a heat radiating layer that is provided under the heat insulating layer, and a heat storing layer that is provided under the heat radiating layer.

### CROSS REFERENCE TO RELATED APPLICATION

The present invention claims the benefit of and contains subject matter related to Japanese Patent Application No. 2008-150375 filed in the Japanese Patent Office on Jun. 9, 2008, the entire contents of which being incorporated herein by reference.

### BACKGROUND

1. Technical Field

The present invention relates to a thermal head that uses a glass layer having low thermal diffusivity.

2. Related Art

Conventional thermal heads have two-layer structure where a glass layer functioning as a heat storing layer is formed on the upper surface of a ceramic substrate made of alumina ceramic or the like as shown in FIG. 3, or a thermal head 1 that is formed of a single glass layer as shown in FIG. 4 (for example, see Japanese Unexamined Patent Application Publication No. 2004-50712 and Japanese Unexamined Patent Application Publication No. 02-200452).

The glass layer of the thermal head having the two-layer structure is formed by printing a pasty glaze material on the upper surface of the ceramic substrate, and performing high-temperature firing. However, since the coefficient of thermal expansion of a material of the ceramic substrate is different from that of the glaze material of the glass layer, there has been a problem in that warpage occurs on the glass substrate after the high-temperature firing or cracks are generated on a laminate interface. Accordingly, specifications, such as the thickness of the glass layer or the ceramic substrate, the aspect ratio of the substrate, and an area ratio, was adjusted in order to cope with the problem such as warpage or the like. However, one drawback is that it is very difficult to adjust the specifications.

Further, the thickness of the thermal head formed of a single glass layer is set to 0.5 mm or less in order to obtain excellent printing characteristics. However, since the thin thermal head is apt to be broken when being handled in the manufacturing process, there has been a problem in that it is difficult to handle the thermal head. In order to solve this problem, it has been considered that the thickness of the glass layer is increased. However, since heat is excessively stored in the thermal head, there has been generated another problem in that printing characteristics deteriorate due to an ink mark such as so-called tailing.

These and other drawbacks exist.

### SUMMARY

An advantage of various embodiments is to provide a thermal head that can easily solve problems such as handling and warpage of a substrate during manufacture, has large the degree of freedom in designing a substrate, and can effectively achieve power saving.

According to an embodiment, a thermal head may include a three-layer structure that includes a heat insulating layer on which heating elements may be formed, a heat radiating layer that may be provided under the heat insulating layer, and a heat storing layer that may be provided under the heat radiating layer.

In the thermal head, the heating elements formed on the heat insulating layer may be disposed so as to be spaced apart from the heat storing layer provided under the heat radiating layer. Accordingly, if thermal responsiveness, a heat radiating property, and a heat storing property according to the thermal diffusivity of each layer are considered, it is possible to easily and appropriately design a thermal head so as to save power.

Further, in the thermal head according to the aspect of the invention, each of the heat insulating layer and the heat storing layer may be a glass layer that is made of the same material formed by high-temperature firing.

In the thermal head, glass layers made of the same material may be formed on and under the heat radiating layer, so that the deformation caused by thermal stress, that is, the warpage of the substrate may be effectively suppressed. A material, which allows heat to be easily controlled, may be selected for the heat radiating layer that is disposed between the heat insulating layer and the heat storing layer. In addition, the total thickness of the thermal head also may be increased due to the three-layer structure, and the thermal head also may be easily handled in a manufacturing process.

As described above, the thermal head according to various embodiments has advantages of easily solving problems such as handling and warpage of a substrate during manufacture, having large the degree of freedom in designing a substrate, and effectively achieving power saving.

### BRIEF DESCRIPTION OF THE DRAWINGS

FIG. 1 is a cross-sectional view of the main structure of a thermal head according to an embodiment of the disclosure.

FIG. 2 is an image view describing the thermal responsiveness of the thermal head according to the embodiment of the invention while the thermal head is compared with a thermal head in the related art.

FIG. 3 is a cross-sectional view of the main structure of a thermal head in the related art.

FIG. 4 is a cross-sectional view of the main structure of another thermal head in the related art.

### DESCRIPTION OF EXEMPLARY EMBODIMENTS

The following description is intended to convey a thorough understanding of the embodiments described by providing a number of specific embodiments and details involving thermal heads. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

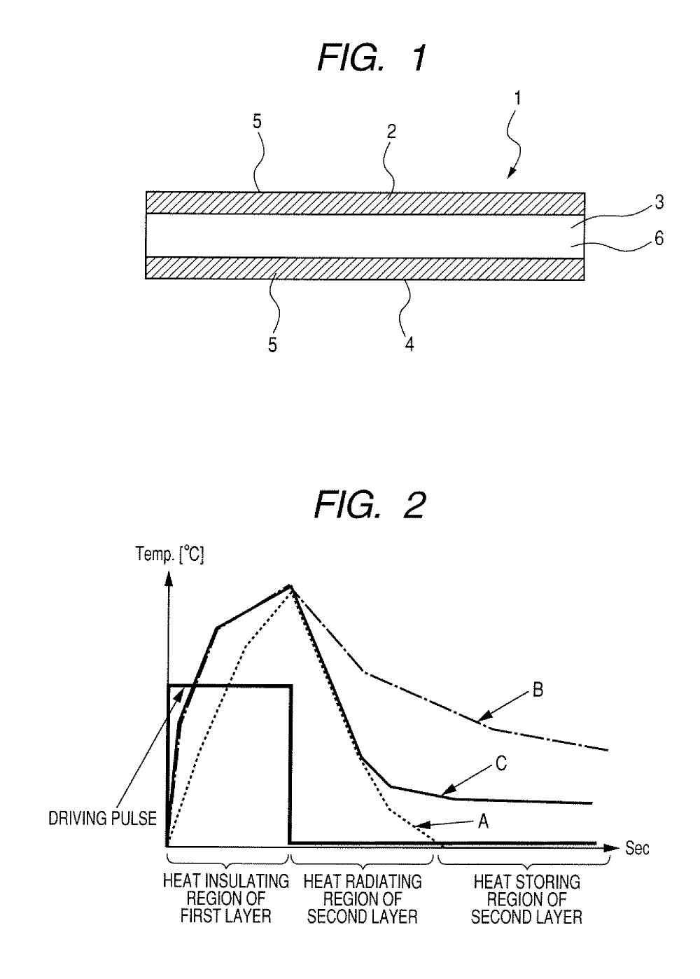

FIG. 1 is a cross-sectional view of the main structure of a thermal head according to an embodiment of the invention.

As shown in FIG. 1, thermal head 1 according to an embodiment may include a three-layer structure that may include a heat insulating layer 2 on which heating elements may be formed, a heat radiating layer 3 that may be provided under the heat insulating layer 2, and a heat storing layer 4 that may be provided under the heat radiating layer 3.

Each of the heat insulating layer 2 and the heat storing layer 4 may be a glass layer 5 made of the same glaze material formed by known high-temperature firing, and the heat radiating layer 3 may be formed of a ceramic layer 6.

Heating elements, electrode patterns, a passivation film, and the like may be formed on the upper surface of the glass layer that functions as the heat insulating layer 2.

Further, the heat radiating layer 3, which may be provided under the heat insulating layer 2, appropriately radiates heat, which is generated by the heating elements formed on the heat insulating layer 2, through heat sinks (not shown) and the like. Further, the heat storing layer 4, which is provided under the heat radiating layer 3, can store heat that may be generated by the heating elements.

In this embodiment, glass having low thermal diffusivity (approximately 0.2 to 0.4 mm²/sec) may be used for the glass layer 5 that forms each of the heat insulating layer 2 and the heat storing layer 4. If the thickness of the glass layer 5 is small as described above, the glass layer 5 is apt to be broken in a manufacturing process, so that it is difficult to handle the glass layer 5. If the thickness of the glass layer 5 is large, heat is excessively stored in the glass layer 5, so that dots of printing results are deformed or a phenomenon such as so-called tailing is apt to occur. Accordingly, adjustment of the thickness of the glass layer 5 is needed so that the heat storing layer 4 can store heat at appropriate temperature as shown in FIG. 2, for example, until the next pulse current is supplied to the thermal head after the insulation and radiation when one pulse current is supplied to the thermal head (one dot).

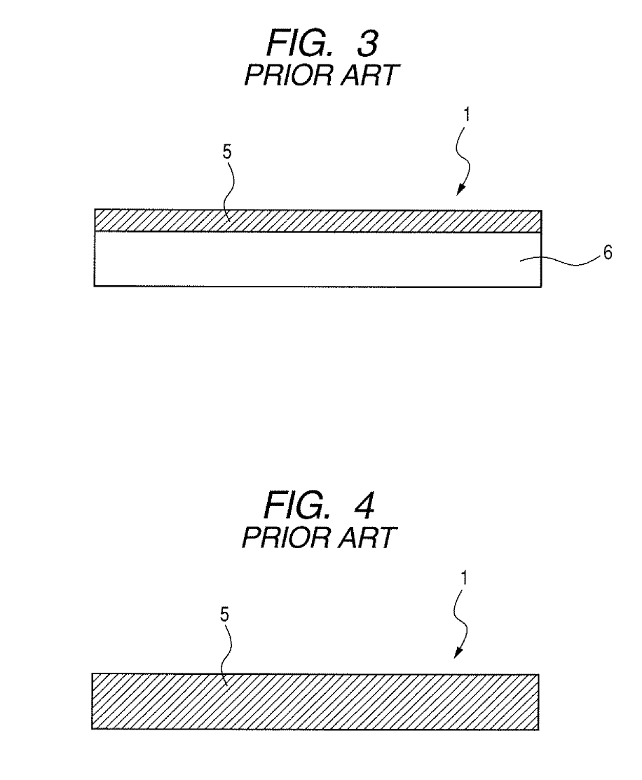

Meanwhile, FIG. 2 shows the temperature change (graph denoted by “A” in FIG. 2) of a thermal head (see FIG. 3) in the related art having two-layer structure where a glaze glass layer functioning as a heat storing layer 4 is formed on the upper surface of a ceramic substrate, the temperature change (graph denoted by “B” in FIG. 2) of a thermal head (see FIG. 4) having single-layer structure where a glass layer having low thermal diffusivity is thick, and the temperature change (graph denoted by “C” in FIG. 2) of the thermal head 1 having three-layer structure according to various embodiments.

Since the thermal diffusivity of the glaze glass layer of the thermal head corresponding to the graph denoted by “A” in FIG. 2 is high as shown in FIG. 2, much time (start-up time) is required until the temperature of a heating element reaches temperature suitable for printing as compared to the other two thermal heads. That is, immediately after current is supplied (one pulse current is applied), thermal responsiveness deteriorates (see a heat insulating region). Further, since the heat radiating layer 3 (ceramic layer 6) radiates heat, it is possible to prevent heat from being excessively stored. However, in contrast, it is understood that there also may be no heat storage effect (see a heat storing region). Meanwhile, the thermal head, which corresponds to the graph denoted by “B” in FIG. 2, may be formed of a single glass layer 5 having low thermal diffusivity. Accordingly, if one pulse current is applied to this thermal head, the temperature of the heating element instantly rises. However, a heat radiation effect is small, so that heat is excessively stored (see a heat storing region). Therefore, if the next current is supplied (one pulse current is applied), the heating element is overheated more than necessary. For this reason, there is a concern that printed dots are deformed or so-called tailing occurs. Accordingly, the thickness of the glass layer 5 may be adjusted so that the thermal head shows the balance of the thermal responsiveness corresponding to the graph denoted by “C” in FIG. 2. In contrast, since the temperature of the heating element of the thermal head corresponding to the graph denoted by “C” in FIG. 2 can instantly rise (see a heat insulating region) by the application of one pulse current, an appropriate heat storage effect is obtained without excessive heat radiation (see a heat radiating region and a heat storing region). Accordingly, it is possible to reduce energy by lowering a driving voltage to be applied next time.

As described above, in the thermal head according to various embodiments, the heat storing layer may be spaced apart from the heating elements formed on the heat insulating layer. Accordingly, it may be possible to lower the driving voltage applied to the heating element without defective printing that is caused by excessive heat storage in the vicinity of the heating element. As a result, it may be possible to achieve power saving.

Further, glass layers made of the same material may be formed on and under the heat radiating layer 3, so that the deformation caused by thermal stress, that is, the warpage of the substrate may be effectively suppressed. Meanwhile, the thicknesses of the heat insulating layer 2 and the heat storing layer 4, which are formed on and under the heat radiating layer 3, are not limited to the same thickness, and may be controlled according to the energy that causes heat generation. Accordingly, it is possible to increase the degree of freedom in designing a thermal head.

Furthermore, a material, which allows heat to be easily controlled, may be selected for the heat radiating layer 3 that is disposed between the heat insulating layer 2 and the heat storing layer 4. That is, the material of the heat radiating layer 3 is not limited to a ceramic material. For example, a metalloid material such as silicon or a metal material such as aluminum may be used as the material of the heat radiating layer 3.

Meanwhile, since the thermal head 1 is not formed of only glass layers 5 and the heat radiating layer 3 formed of a ceramic layer 6 is interposed between the glass layers 5, it may be easy to handle the thermal head 1 in the manufacturing process.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A thermal head, comprising:
a three-layer structure, the three-layer structure including:
a heat insulating layer on which heating elements are formed, a heat radiating layer that is provided under the heat insulating layer, and a heat storing layer that is provided under the heat radiating layer.

2. The thermal head according to claim 1,
wherein each of the heat insulating layer and the heat storing layer is a glass layer that is made of the same material formed by high-temperature firing.

3. The thermal head according to claim 1,
wherein the glass layer has thermal diffusivity in the range of 0.2 to 0.4 (mm²/sec).

4. The thermal head according to claim 2,
wherein the glass layer has thermal diffusivity in the range of 0.2 to 0.4 (mm²/sec).
